(19) United States
(12) Patent Application Publication
(10) Pub. No.: US 2020/0380550 A1
(43) Pub. Date: Dec. 3, 2020

(54) REWARDS-RETRIEVING MOBILE APPLICATION

(71) Applicant: Fetch Rewards LLC, Madison, WI (US)

(72) Inventors: Wes Schroll, Madison, WI (US); Heidi Wagner, Verona, WI (US); Michael R. Loeb, New York, NY (US)

(21) Appl. No.: 16/424,698

(22) Filed: May 29, 2019

(51) Int. Cl. G06Q 30/02; G06Q 20/40

(52) U.S. Cl. CPC G06Q 30/0233; G06Q 20/4014; G06Q 30/0239; G06Q 30/0215

(57) ABSTRACT

Provided is a mobile application and system which can provide rewards to a user based on purchases of various brands, companies, and the like, in a non-intrusive manner. In one example, the method may include storing user verification credentials in a database, receiving an input value via a mobile application installed on a user device and transmitted to a host platform that hosts the mobile application, calling a verification service based on the stored user verification credentials, via an application programming interface (API), which verifies a payment account of the user can cover the input value, and in response to receiving verification from the verification service, fetching a pre-loaded token from a token service based on the input value and transmitting the pre-loaded token to the mobile application installed on the user device.

### BACKGROUND

Loyalty programs have proven to be one of the most effective tactics for increasing revenue and inspiring customer loyalty. These programs, also referred to as rewards, are structured marketing strategies that are designed by merchants to encourage customers to continue to shop at or use the services of the business. Loyalty programs cover most types of commerce, and can have varying features and rewards-schemes. For example, fields such as banking, entertainment, hospitality, retailing, and travel, can provide users with a card such as a loyalty card or the like which is visually similar to a credit card, debit card, or digital card that identifies the card holder as a participant in a loyalty program. By presenting these cards, users can receive a discount on a current purchase, an allotment of points that they can use for future purchases, and the like.

Few loyalty programs allow a consumer to earn rewards by making purchases at multiple businesses. Credit cards, however provide loyalty programs based on the use of the credit card in making purchases. These rewards can be earned by a consumer by simply making a purchase using the credit card. However, credit cards require purchases to be put on “credit” and paid back at a later time. As a result, credit cards can create negative consequences for a consumer such as debt, monthly payments, lowered credit score, and the like. Accordingly, what is needed is a non-intrusive mechanism that allows a consumer to earn rewards without having to enroll in a new credit card.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a system for retrieving rewards during a checkout process in accordance with an example embodiment.

FIG. 2 is a diagram illustrating a process of pushing opportunities to a consumer based on geo-location in accordance with an example embodiments.

FIG. 3 is a diagram of linking a payment account to a rewards-based mobile application in accordance with an example embodiment.

FIG. 4 is a diagram illustrating a communication sequence for retrieving a reward during a checkout process in accordance with an example embodiment.

FIG. 5 is a diagram illustrating a method of retrieving rewards in accordance with an example embodiment.

FIG. 6 is a diagram illustrating a computing system for use in the example embodiments described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

The example embodiments are directed to a mobile application which can fetch rewards for a user based on purchases at various businesses without requiring the user to sign-up for a credit card. The user may download and install the mobile application onto their mobile device. Once installed, the user may link a pre-existing bank account, payment account, payment card, credit card, and the like, with the mobile application. As the user dynamically moves around, a geo-location of the user may be uploaded (e.g., periodically, etc.) to a host platform of the mobile application. Based on the geo-location, the host platform can detect a merchant at which the user is located or detect one or more merchants within a predetermined distance of the user. In response, the host platform can identify available rewards for any of the merchants within the predetermined distance of the user and push a notification of the rewards to the mobile device.

When the user performs a checkout process such as through a point-of-sale (POS) terminal at the merchant, the user may determine a purchase total and input the purchase total into a user interface of the mobile application. The host platform may then retrieve a pre-loaded token (e.g., a gift card, etc.), charge the pre-existing account of the user, and forward the pre-loaded token to the mobile device. The host platform can apply the rewards to the user based on a rewards account offered by the mobile application. The user may go from business-to-business, store-to-store, without having to enroll in a loyalty program or sign-up for a credit card, and earn rewards points using the mobile application. The rewards program provides a non-intrusive opportunity for consumers to earn rewards without requiring users to sign-up for credit cards.

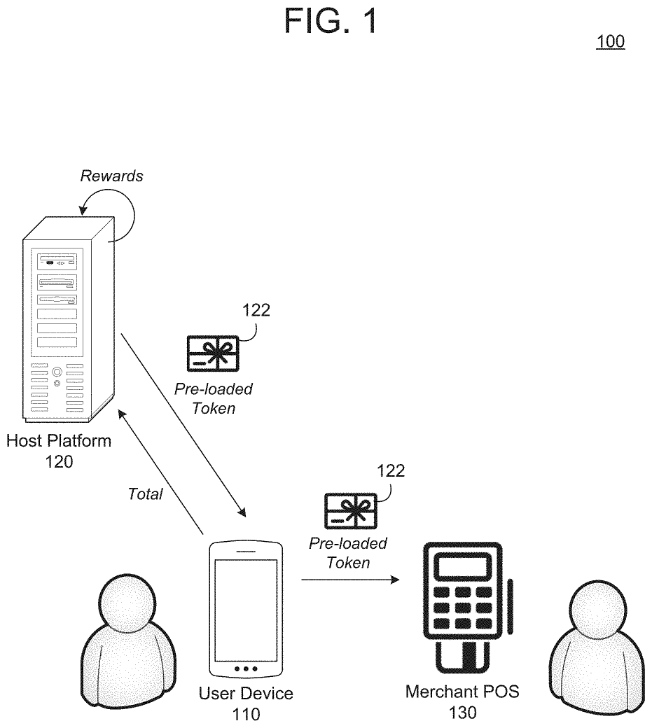

FIG. 1 illustrates a system 100 for retrieving rewards during a checkout process in accordance with an example embodiment. A user may download and install a mobile application for retrieving rewards to a user device 110, for example, a smart phone, a tablet, a laptop, an MP3 player, a smart wearable, and the like. A host platform 120 of the mobile application may receive geo-location information such as global positioning system (GPS) coordinates, network address information, street address information, and the like, which can be transmitted from the user device 110 to the host platform 120 at intervals, for example, periodic, intermittent, randomly, etc. Here, the host platform 120 and the user device 110 may be connected via a network such as the Internet.

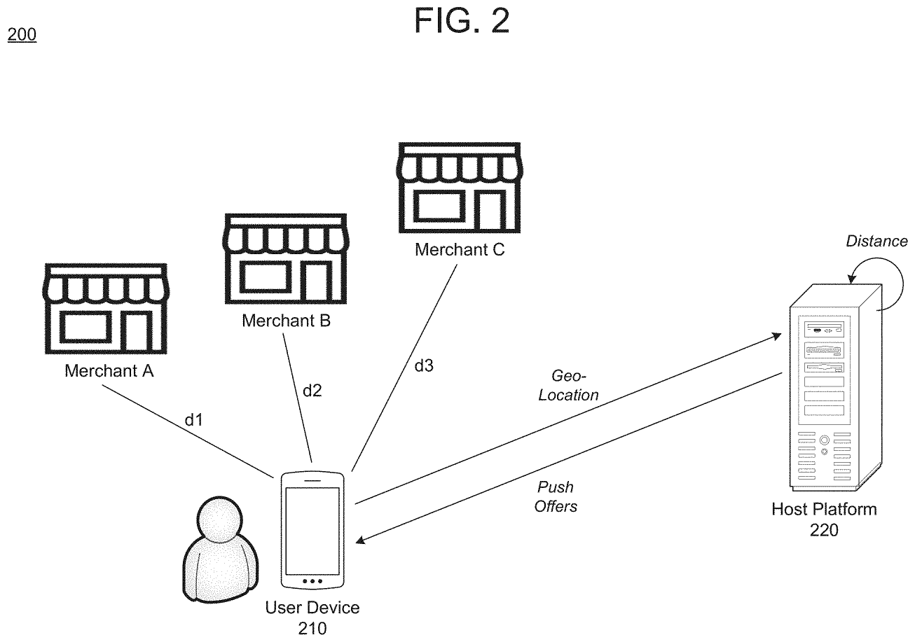

Accordingly, the host platform 120 may identify a merchant or merchants near the user or a merchant location at where the user is presently located based on the geo-location information. This can help the host platform 120 identify rewards which can be pushed to the user device 110 such as described in the example of FIG. 2.

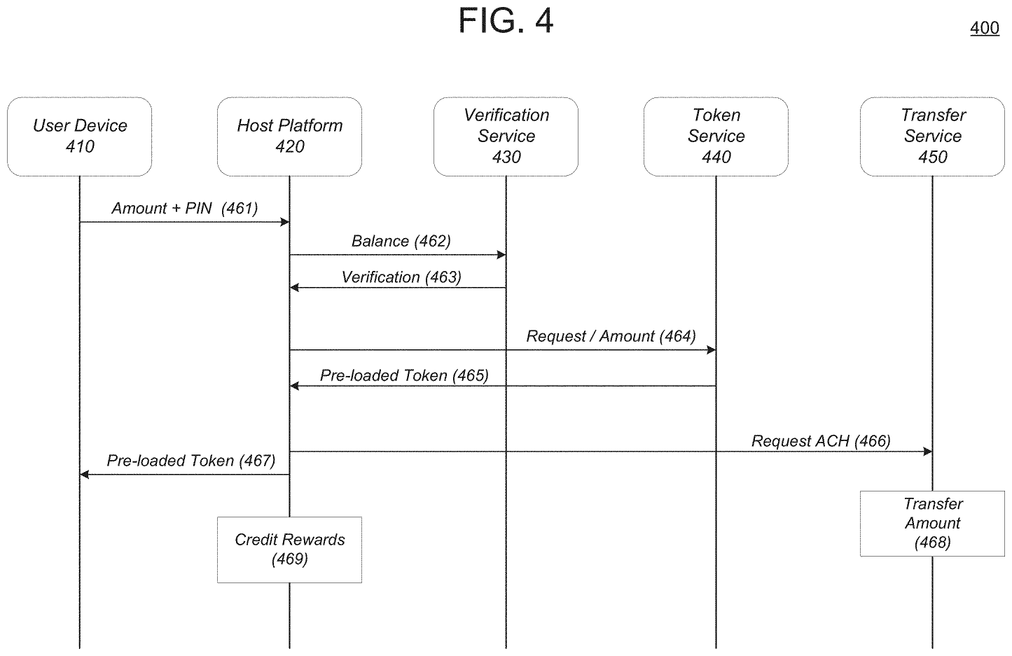

During a purchase process, the user may access the mobile application on the user device 110. According to various embodiments, when the user receives a total from the merchant, the user may input the total (e.g., purchase price) into a user interface of the mobile application executing on the user device 110. The input value may be submitted to the host platform 120 via the mobile application. In response, the host platform 120 may retrieve a pre-loaded token such as a gift card, or the like, from an external token service (shown in FIG. 4). The pre-loaded token may represent the total amount of the purchase, more than the amount of the total purchase, less than the amount of the total purchase, or the like.

The host platform 120 may transmit the pre-loaded token to the user device 110. The retrieval process may take a few seconds. As a result, the user can receive the pre-loaded loaded token almost immediately. The user may then provide the pre-loaded token, for example, a barcode, a serial number, or the like, which can be scanned off of the user device 110 by a merchant point-of-sale (POS) terminal 130, or entered by the merchant into a keypad and/or user interface of the merchant POS terminal 130. Furthermore, the host platform 120 may store a rewards account for the user at the host platform 120. The host platform 120 may add rewards to the user's rewards account based on the purchase. This allows the user to earn rewards for purchases at any number of different merchants without having to enroll in a new credit card.

FIG. 2 illustrates a process 200 of pushing opportunities to a consumer based on geo-location in accordance with an example embodiments. Referring to FIG. 2, a user device 210 having a mobile application as described herein installed therein and executing may upload location information to a host platform 220. The geo-location information may include latitude and longitude components, a timestamp, a street address, a network signal strength, an IP address, and the like, which can be used to detect a geographical location of the user device 210.

In response to receiving the geolocation information from the user device 210, the host platform 220 may identify merchants (retail locations, stores, brick and mortar, etc.) which are located within a predetermined distance from the user device 210. Here, the predetermined distance may include a distance d1 between the user device 210 and a merchant A and a distance d2 between the user device 210 and a merchant B. However, a merchant C may be at a distance d3 which is greater than the predetermined distance. Therefore, the host platform 220 may identify that merchants A and B are located near the user device 210 and retrieve reward opportunities that are presently available to the user for the merchants A and B. The host platform 220 may push these reward opportunities to a screen of the user device 210. For example, the opportunities may be pop-ups on the screen, notifications on the screen, or the like. Therefore, the user may receive reward opportunities automatically from the host platform 220 as the user moves near merchant locations.

In some embodiments, the geolocation received from the user device 210 may enable the host platform 220 to identify a merchant premise (e.g., store boundary, etc.) where the user is currently located. Based on this information, when the user goes to checkout at the merchant location, the host platform 220 may automatically provide a user screen associated with the merchant and offer a gift card corresponding to that merchant. This can greatly simplify the process for the user because the option to purchase a gift card of the merchant and receive a corresponding rewards may be provided automatically on the screen of the user device 210.

In some embodiments, the mobile application installed on the user device 210 may be used to gain rewards by scanning receipts. For example, consumers may earn rewards for the shopping they are doing in any store. They get rewards by uploading their receipt into the mobile application and are awarded points. The points that are accrued can then be traded in for gift cards.

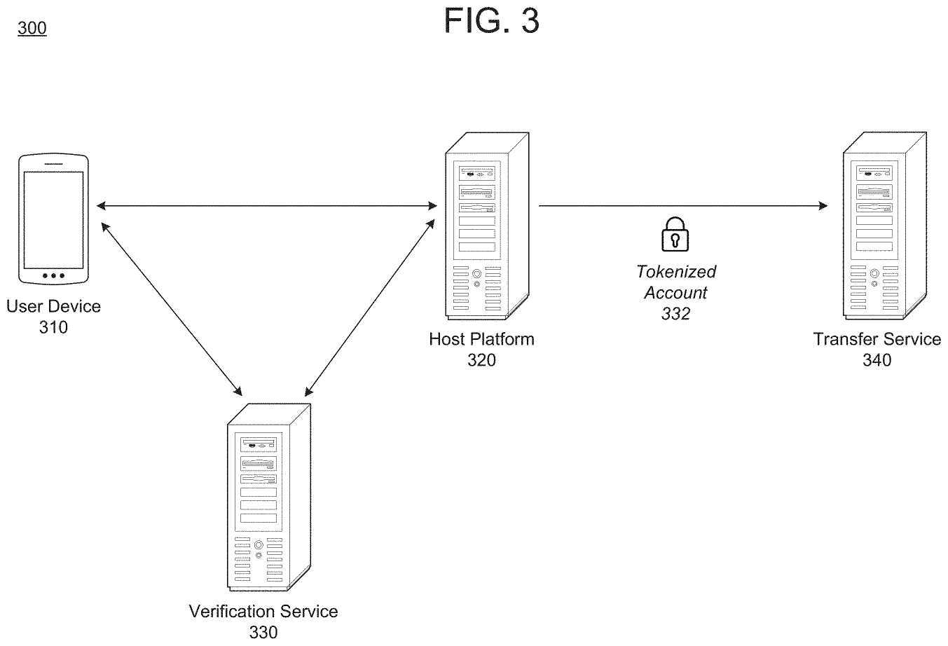

The use of the pre-loaded token provides an added benefit because the user is able to receive rewards immediately and without having to upload the receipt because the proof is in the use of the gift card (pre-loaded token). The mobile application may incentivize a user to provide payment information to be uploaded in advance of their shopping (registration). For example, when the user is at the counter, they can open the mobile application and put in the total and create a transaction which sends money to host platform 220 as further described in the examples of FIGS. 3 and 4. The host platform 220 can utilize an ACH network and purchase a gift card that can be used at the POS terminal of the retailer in lieu of the consumer making payment with their debit/credit card.

In the example of FIG. 2, the host platform 220 may include an identification system based on geo-location. Here, the host platform 220 can understand that the user is located at a particular merchant, and send the user (push) deals for that merchant. In return for that, the end user is being provided with an additional point opportunity with the mobile application.

The host platform may choose a gift card to return based on location/store. Furthermore, the host platform 220 may execute an algorithm to select the point value to be credited based on history or current point totals of the user's rewards account with the host platform 220. For example, the if the user is 1000 points away from a next gift card, the host platform 220 can offer to pay the balance of points needed to get you to the reward (prior purchasing history) to determine the appropriate point value. In some embodiments, the algorithm may determine the value of the gift card to offer based on shopping history or point total. Here, the value of the reward may be based on the amount of the gift card being taken. In some embodiments, the host platform 220 may include an accrual mechanism which takes remaining value (unused value) from a gift card and applies it to a next gift card downloaded to the user.

FIG. 3 illustrates a system 300 performing a process for linking a payment account of a user to a rewards-based mobile application in accordance with an example embodiment. Referring to FIG. 3, a user device 310 includes a mobile application according to various embodiments which has been installed and is executing thereon. In a first step, a user may access the mobile application on the user device 310 and select a “Link my Account” option, or the like. This request may be sent to a host platform 320 which hosts the mobile application. In a second step, the host platform 320 may call a verification service 330 which can be used by the user to select a bank or other financial institution and put in payment account credentials of an existing payment account such as a checking account, debit card, credit card, or the like.

In a third step, the verification service 330 verifies the user's credentials with their bank or other institution. Here, the verification service 330 may provide one or more application programming interfaces (APIs) which enable the user on the user device 310 to communicate with their financial institution/bank through the verification service 330. In response, the verification service 330 may determine if the payment account is valid and also if the user is authenticated to use the payment account.

In response to successful verification, in a fourth step, the verification service 330 may provide information indicating the bank account is valid and also authenticating the account to the user device 310. In a fifth step, the user device 310 may send this information to the host platform 320 where it is stored in a database along with a PIN chosen by the user. In a sixth step, the host platform 320 then uses this information to obtain a token (tokenized account information 332) from the verification service 330. Here, the token represents the payment account of the user, but without disclosing sensitive financial information such as the account number, the user's name, the expiry, CVC, or any other sensitive data. Using the token, in a seventh step the host platform 320 may call a transfer service 340 and register the user there by creating a customer ID and a funding source using the tokenized account information 332.

In this example, the token that is generated may prevent the transfer service 340 from identifying financial details of the user's payment account other than a name of the financial institution and/or an account name. The token is not payment enabled. When the host platform 320 purchases a pre-loaded token on behalf of the user device, the host platform 320 may transfer funds by calling the transfer service 340 which can transfer the money from the created funding source of the user to an already existing funding source associated with the host platform 320.

In the examples herein, the host platform 320 performs the role of an orchestration service between the calls and transfers among the verification service 330, the transfer service 340, and a pre-loaded token generator service (shown as 440 in FIG. 4). The customer has no idea that all this is happening behind the scenes. The end result of the linking process provides a tokenized representation of the user's payment account to be stored by the transfer service 340 and called for subsequent gift card purchases, etc.

FIG. 4 illustrates a communication sequence 400 for retrieving a reward during a checkout process in accordance with an example embodiment. In the example of FIG. 4, during the process 400 the user performs a checkout at a merchant payment terminal. In this example, the user has already linked a payment account to their mobile application running on their user device 410 and hosted by a host platform 420. When the user walks into a retailer, and has the geo-location services enabled on the user device 410, the user device may send a call to the host platform 420 and request any rewards available with at the geo-location. Here, the location-enabled mobile application knows a predetermined geographical area of the user device 410 (i.e., where the user is standing, sitting, etc.) The host platform 420 determines one or more rewards based on a predetermined distance from where the user is standing and pushes the available rewards opportunities to the user device 410 without a request. For example, a screen on the user device may say, “When you are ready to checkout, use Fetch Pay and we will give you a reward . . . .”

When the user arrives at the merchant payment terminal the terminal may provide the user with a total purchase price. In 461, the user may open up the mobile application and input the total into the app (only the merchant card is shown) and a user authentication PIN for validation of the user accessing the application. When the user inputs the amount and enters their PIN, in 461 they hit submit in the mobile app, and mobile app calls the host platform 420. In 462, the host platform 420 looks up the user's linked account and “pings” the verification service 430 to ensure that the payment account has sufficient funds to cover the purchase total. In 463, the verification service 430 returns a yes/no to the host platform 420.

When the user has enough money in their payment account to cover the purchase price, in 464 the host platform 420 calls a token service 440 to provide a pre-loaded token based on the total purchase price. Here, the pre-loaded token may be a gift card, etc. which covers the total purchase price. In 465, the token service 440 may provide the pre-loaded token to the host platform 420.

In response to receiving the pre-loaded token, in 466 the host platform 420 request a transaction (e.g., an ACH transaction, etc.) to the transfer service 450 to transfer the funds from the user's funding source to the funding source of the host platform 420 which are stored by the transfer service 450. In addition, in 467 the host platform provides the pre-loaded token to the user device 410. Here, the pre-loaded token may include an image, a barcode, a serial number, or the like, along with an amount of rewards points that are earned by making the purchase using the pre-loaded token. In this example, steps 466 and 467 are performed in sequence, however, it should be appreciated that they could be performed simultaneously. Also, it should be appreciated that step 467 may be performed before step 466.

In 468, the transfer service 450 initiates the ACH transaction between customer's funding source and host platform 420 funding source. The money then moves from the user's account to an account associated with the host platform 420 in a daily clearing/settlement process. Furthermore, in 469, the user's rewards account at the host platform 420 is credited with the rewards. Here, the user may receive a certain percentage back in points which can be used for gifts and rewards. This is where the user gets the reward that was promised to them based on their geolocation. The host platform 420 is providing a user with a rewards program without requiring the user to sign up for a credit card (non-intrusive rewards program).

Although not shown in FIG. 4, as another example, a user may obtain a pre-loaded token from the host platform 420 even though they are not checking out at a merchant location. For example, the user may obtain a pre-loaded token while at home, work, school, etc. In this case, the user may open the mobile application on the user device 410, and input an amount that they want to purchase (e.g., a $100 pre-loaded token, etc.). In response, the host platform 420 may verify the user's account balance, and fetch a corresponding gift card from the token service 440. The pre-loaded token can be provided to the user device 410 enabling the pre-loaded token to be used at home during an online checkout process (e.g., e-commerce website, etc.). As another example, the user could print out the pre-loaded token in paper form and use it at a merchant which does not accept/read electronic gift cards. As is similar in process 400, the host platform 420 may initiate a funds transfer with the transfer service 450 based on the amount of the pre-loaded token requested by the user.

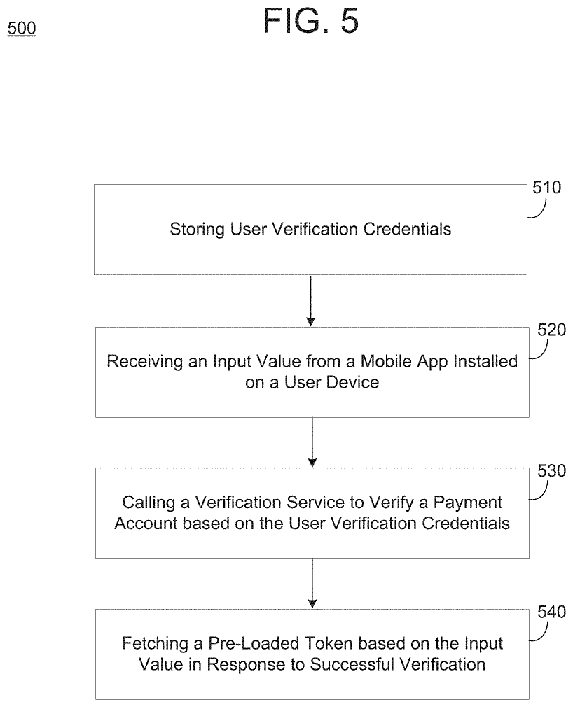

FIG. 5 illustrates a method 500 of retrieving rewards in accordance with an example embodiment. For example, the method 500 may be performed by a computing device or a group of computing devices, such as a user device, a web server, a cloud platform, a distributed database, a blockchain, and the like. Referring to FIG. 5, in 510, the method may include storing user verification credentials in a database. For example, the user verification credentials may be stored based on a link my account process performed between a user device and a verification service, via a host platform. The verification credentials may include a token which can identify the user's payment account at the verification service without providing any personal information associated with the user's account such as sensitive payment account details (account number, expiry, name, etc.)

In 520, the method may include receiving an input value via a mobile application installed on a user device and transmitted to a host platform that hosts the mobile application. Here, the input value may include a purchase total that is input by the user via a user interface of the mobile application installed on the user's device. In some embodiments, the user may also input a PIN or other security code to authenticate the user with the host platform. In some embodiments, the input value may be a total of a purchase being requested from a merchant during a checkout process between the user and the merchant.

In 530, the method may include calling the verification service based on the stored user verification credentials, via an API of the verification service. Here, the verification service may verify that the payment account of the user has sufficient funds to cover the input value (purchase price). Here, the verification service may perform the verification without disclosing sensitive payment account details with the host platform. In response to receiving verification from the verification service, in 540, the method may include fetching a pre-loaded token from a token service based on the input value and transmitting the pre-loaded token to the mobile application installed on the user device. The pre-loaded token may be a gift card and may be represented by a bar code, an ID, or the like, capable of digital transfer. In some embodiments, the fetching may further include applying the reward to a user profile stored at the host platform.

In some embodiments, the method may further include transmitting, to a transfer service, a request to transfer funds from the payment account of the user to a payment account associated with the host platform based on the retrieved pre-loaded token. In some embodiments, the method may further include retrieving a tokenized account identifier of the payment account of the user from the verification service. In some embodiments, the method may further include generating a funding source for the user at the transfer service based on the retrieved tokenized account identifier. In some embodiments, the method may further include receiving geo-location information from the user device and pushing rewards to the user device based on the geo-location of the user device. For example, the pushing may include identifying a merchant within a predetermined distance of the geo-location of the user device, and transmitting a reward associated with the merchant to the user device.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

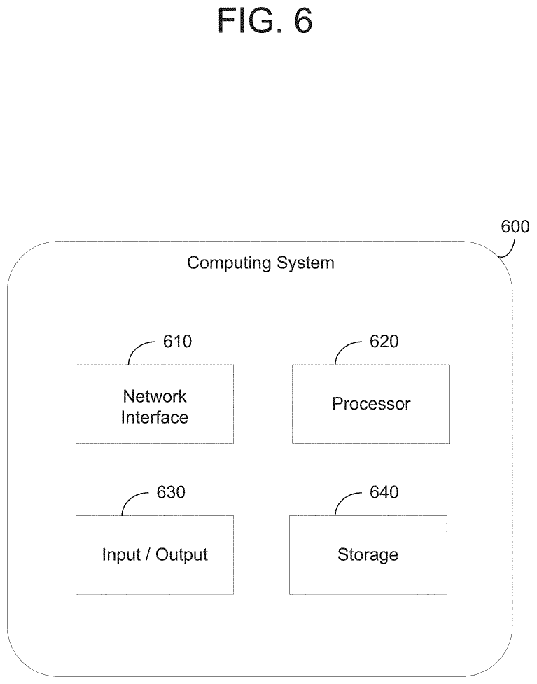

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 6 illustrates an example computing system 600 which may represent or be integrated in any of the above-described components, etc. FIG. 6 is not intended to suggest any limitation as to the scope of use or functionality of embodiments described herein. The computing system 600 is capable of being implemented and/or performing any of the functionality set forth hereinabove.

The computing system 600 may include a computer system/server, which is operational with numerous other general purpose or special purpose computing system environments or configurations. Examples of well-known computing systems, environments, and/or configurations that may be suitable for use as computing system 600 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 600 may be a tokenization platform, server, CPU, or the like.

The computing system 600 may be described in the general context of computer system-executable instructions, such as program modules, being executed by a computer system. Generally, program modules may include routines, programs, objects, components, logic, data structures, and so on that perform particular tasks or implement particular abstract data types. The computing system 600 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 6, the computing system 600 is shown in the form of a general-purpose computing device. The components of computing system 600 may include, but are not limited to, a network interface 610, one or more processors or processing units 620, an output 630 which may include a port, an interface, etc., or other hardware, for outputting a data signal to another device such as a display, a printer, etc., and a storage device 640 which may include a system memory, or the like. Although not shown, the computing system 600 may also include a system bus that couples various system components including system memory to the processor 620.

The storage 640 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random access memory (RAM) and/or cache memory. As another example, storage device 640 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 640 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 600 may also communicate with one or more external devices such as a keyboard, a pointing device, a display, etc.; one or more devices that enable a user to interact with computer system/server; and/or any devices (e.g., network card, modem, etc.) that enable computing system 600 to communicate with one or more other computing devices. Such communication can occur via I/O interfaces. Still yet, computing system 600 can communicate with one or more networks such as a local area network (LAN), a general wide area network (WAN), and/or a public network (e.g., the Internet) via network interface 610. As depicted, network interface 610 may also include a network adapter that communicates with the other components of computing system 600 via a bus. Although not shown, other hardware and/or software components could be used in conjunction with the computing system 600. Examples include, but are not limited to: microcode, device drivers, redundant processing units, external disk drive arrays, RAID systems, tape drives, and data archival storage systems, etc.

According to various embodiments, the storage 640 may store user verification credentials in a database. Here, the user verification credentials may include a token representing the user's payment account at a verification service. However, the user verification credentials may not include sensitive account data such as an account number, a user name, an address, a phone number, or the like. Rather, the token may simply be used to request the verification service to verify funding in the user's payment account. The network interface 610 may receive an input value which is input via a mobile application installed on a user device and transmitted to a host platform that hosts the mobile application.

In response, the processor 620 may call the verification service based on the stored user verification credentials, via an API, which verifies a payment account of the user can cover the input value, and, in response to receiving verification from the verification service, fetch a pre-loaded token from a token service based on the input value and transmit the pre-loaded token to the mobile application installed on the user device.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store user verification credentials in a database;
a network interface configured to receive an input value which is input via a mobile application installed on a user device and transmitted to a host platform that hosts the mobile application; and
a processor configured to call a verification service based on the stored user verification credentials, via an application programming interface (API), which verifies a payment account of the user can cover the input value, and, in response to receiving verification from the verification service, fetch a pre-loaded token from a token service based on the input value and transmit the pre-loaded token to the mobile application installed on the user device.

2. The computing system of claim 1, wherein the processor is further configured to control the network interface to transmit, to a transfer service, a request to transfer funds from the payment account of the user to a payment account associated with the host platform based on the retrieved pre-loaded token.

3. The computing system of claim 1, wherein the processor is further configured to retrieve a tokenized account identifier of the payment account of the user from the verification service.

4. The computing system of claim 3, wherein the processor is further configured to generate a funding source for the user at the transfer service based on the retrieved tokenized account identifier.

5. The computing system of claim 1, wherein the processor is further configured to detect geo-location information from the user device and control the network interface to push rewards to the user device based on the geo-location of the user device.

6. The computing system of claim 5, wherein the processor is configured to identify a merchant within a predetermined distance of the geo-location of the user device, and transmit a reward associated with the merchant to the user device.

7. The computing system of claim 6, wherein the processor is further configured to apply the reward to a user profile stored at the host platform.

8. The computing system of claim 1, wherein the processor is further configured to receive a personal identification code input via the mobile application installed on the user device and verify, at the host platform, that the personal identification code is associated with the user.

9. A method comprising:
storing user verification credentials in a database;
receiving an input value via a mobile application installed on a user device and transmitted to a host platform that hosts the mobile application;
calling a verification service based on the stored user verification credentials, via an application programming interface (API), which verifies a payment account of the user can cover the input value; and
in response to receiving verification from the verification service, fetching a pre-loaded token from a token service based on the input value and transmitting the pre-loaded token to the mobile application installed on the user device.

10. The method of claim 9, further comprising transmitting, to a transfer service, a request to transfer funds from the payment account of the user to a payment account associated with the host platform based on the retrieved pre-loaded token.

11. The method of claim 9, further comprising retrieving a tokenized account identifier of the payment account of the user from the verification service.

12. The method of claim 11, further comprising generating a funding source for the user at the transfer service based on the retrieved tokenized account identifier.

13. The method of claim 9, further comprising receiving geo-location information from the user device and pushing rewards to the user device based on the geo-location of the user device.

14. The method of claim 13, wherein the pushing comprises identifying a merchant within a predetermined distance of the geo-location of the user device, and transmitting a reward associated with the merchant to the user device.

15. The method of claim 14, wherein the fetching further comprises applying the reward to a user profile stored at the host platform.

16. The method of claim 9, wherein the receiving further comprises receiving a personal identification code input via the mobile application installed on the user device and verifying, at the host platform, that the personal identification code is associated with the user.

17. A non-transitory computer-readable medium storing instructions which when executed by a processor cause a computer to perform a method comprising:
storing user verification credentials in a database;
receiving an input value via a mobile application installed on a user device and transmitted to a host platform that hosts the mobile application;
calling a verification service based on the stored user verification credentials, via an application programming interface (API), which verifies a payment account of the user can cover the input value; and
in response to receiving verification from the verification service, fetching a pre-loaded token from a token service based on the input value and transmitting the pre-loaded token to the mobile application installed on the user device.

18. The non-transitory computer readable medium of claim 17, wherein the method further comprises transmitting, to a transfer service, a request to transfer funds from the payment account of the user to a payment account associated with the host platform based on the retrieved pre-loaded token.

19. The non-transitory computer readable medium of claim 17, wherein the method further comprises retrieving a tokenized account identifier of the payment account of the user from the verification service.

20. The non-transitory computer readable medium of claim 17, wherein the method further comprises receiving geo-location information from the user device and pushing rewards to the user device based on the geo-location of the user device.
